(19) United States
(12) Patent Application Publication
(10) Pub. No.: US 2002/0153221 A1
(43) Pub. Date: Oct. 24, 2002

(54) Friction clutch

(75) Inventor: Wolfgang Schnepf, Wiernsheim (DE)

Correspondence Address: Kevin P. Moran, Michael Best & Friedrich LLP, 100 East Wisconsin Avenue, Milwaukee, WI, 53202-4108, US

(73) Assignee: Harley-Davidson Motor Company Group, Inc., Milwaukee, WI

(21) Appl. No.: 10/126,337

(22) Filed: Apr. 19, 2002

(30) Foreign Application Priority Data
Apr. 20, 2001 (DE) 101 19 334.3

(51) Int. Cl. F16D 3/66; F16D 3/14

(52) U.S. Cl. 192/70.17; 192/214

(57) ABSTRACT

A friction clutch includes a driving gearwheel, a clutch hub, and a clutch cage. The clutch cage and the clutch hub are coupled together by way of non-positive frictional forces in the clutch cage. A driving disc is fixed to the clutch cage, and a gearbox input shaft is in toothed or splined engagement with the clutch hub. Torsional springs are interposed between the clutch cage and a driving gearwheel to permit the driving gearwheel to rotate within a limited range of motion with respect to the clutch cage. The driving gearwheel meshes with a primary gearwheel on a crankshaft. The crankshaft drives rotation of the gearbox input shaft through the driving gearwheel, the torsional springs, the clutch cage, and the clutch hub. A friction device is interposed between a collar of the driving gearwheel and the driving disc. The friction device damps torsional vibrations by non-positively coupling the driving gearwheel with the driving disc in the radial direction.

### FIELD OF THE INVENTION

The invention relates to friction clutches, and more particularly to friction clutches including torsional damping elements.

### BACKGROUND OF THE INVENTION

It is known for a friction clutch to use a friction device to damp torsional vibrations between the engine and the gearbox. In such known constructions, the friction device commonly includes a deflectable damping element (e.g., a cup spring, Belleville washer, or the like). These known constructions require an axial pressing force to deflect the damping element. The axial pressing force often causes elements within the friction clutch to be pressed together, which may result in premature wear of those parts, or may create unwanted friction in other parts of the clutch

### SUMMARY OF THE INVENTION

The present invention provides a friction device for damping the torsional vibrations in a friction clutch. The friction device of the present invention is capable of producing a high damping moment in the absence of the high axial pressing force discussed above. Additionally, the friction clutch of the present invention may be produced in a simple and inexpensive manner and from few components.

More specifically, the present invention provides a friction clutch comprising a clutch cage, a driving gearwheel rotatably coupled to the clutch cage, and a friction element compressed between the clutch cage and the driving gearwheel by a substantially radial force. The friction clutch may also include a twist gearwheel and a twist spring disposed between the twist gearwheel and the driving gearwheel. The twist spring preferably biases the twist gearwheel and the driving gearwheel toward circumferentially offset positions. Torsion springs may also be provided between the driving gearwheel and the clutch cage. The torsion springs are preferably the sole means for coupling the driving gearwheel and the clutch cage for rotation together. In this respect, the friction element dampens oscillations of the torsion springs as the driving gearwheel and the clutch cage rotate with respect to each other. Preferably, the clutch cage includes a first radial surface and the driving gearwheel includes a second radial surface facing the first radial surface and the friction element is compressed between the first and second radial surfaces.

The present invention also provides a motorcycle comprising a frame, a rear wheel supporting a rear end of the frame, a front wheel supporting a front end of the frame, an engine assembly mounted to the frame and having a rotating output shaft; and a friction clutch selectively operable to couple the output shaft and the rear wheel. The friction clutch includes a clutch cage, a driving gearwheel rotatably coupled to the clutch cage, and a friction element compressed between the clutch cage and the driving gearwheel by a substantially radial force. The motorcycle may also include a twist gearwheel and a twist spring disposed between the twist gearwheel and the driving gearwheel. The twist spring preferably biases the twist gearwheel and the driving gearwheel toward circumferentially offset positions. Torsion springs may also be provided between the driving gearwheel and the clutch cage.

The present invention further provides a method of damping oscillations in a friction clutch having a clutch cage and a driving gearwheel pivotally coupled together for rotation. The method comprises providing an elastic coupling member between the clutch cage and the driving gearwheel, radially compressing a friction element between the clutch cage and the driving gearwheel, transferring rotation of the driving gearwheel to the clutch cage via the elastic coupling member, which oscillates in response to rotation of the clutch cage and the driving gearwheel, and damping oscillations of the elastic coupling member with frictional forces provided by the friction element. The method may also include providing a twist gearwheel and a twist spring between the twist gearwheel and the driving gearwheel, and biasing the twist gearwheel and the driving gearwheel toward circumferentially offset positions with the twist spring. Additionally, the method may include securing a driving disk to the clutch cage and interposing the driving gearwheel between the clutch cage and the driving disc.

The present invention still further provides a friction clutch for coupling a driving shaft and a driven shaft for rotation together. The friction clutch comprises a friction coupling mechanism frictionally coupled to the driving shaft, and a driving gearwheel engaging a driven gearwheel on the driven shaft and being pivotable with respect to the friction coupling mechanism. An elastic coupling member interconnects the driving gearwheel and the friction coupling mechanism, and permits the driving gearwheel to pivot with respect to the friction coupling mechanism within a limited range of motion. A damping member frictionally engages the driving gearwheel in a substantially radial direction to dampen torsional vibrations between the driving gearwheel and the friction coupling mechanism.

Other features and advantages of the invention will become apparent to those skilled in the art upon review of the following detailed description, claims, and drawings.

### BRIEF DESCRIPTION OF THE DRAWINGS

FIG. 1 is a side elevation view of a motorcycle embodying the present invention.

FIG. 2 is a partially exploded view of an engine housing with a friction clutch.

FIG. 3 is a plan view of a friction clutch in partial-section.

FIG. 4 is a sectional illustration along the line IV-IV in FIG. 3.

FIG. 5 is a plan view of a friction clutch in accordance with a second embodiment in partial-section.

FIG. 6 is a sectional illustration along the line VI-VI in FIG. 5.

Before one embodiment of the invention is explained in detail, it is to be understood that the invention is not limited in its application to the details of construction and the arrangements of the components set forth in the following description or illustrated in the drawings. The invention is capable of other embodiments and of being practiced or being carried out in various ways. Also, it is understood that the phraseology and terminology used herein is for the purpose of description and should not be regarded as limiting. The use of “including” and “comprising” and variations thereof herein is meant to encompass the items listed thereafter and equivalents thereof as well as additional items. The use of “consisting of” and variations thereof herein is meant to encompass only the items listed thereafter. The use of letters to identify elements of a method or process is simply for identification and is not meant to indicate that the elements should be performed in a particular order.

### DETAILED DESCRIPTION

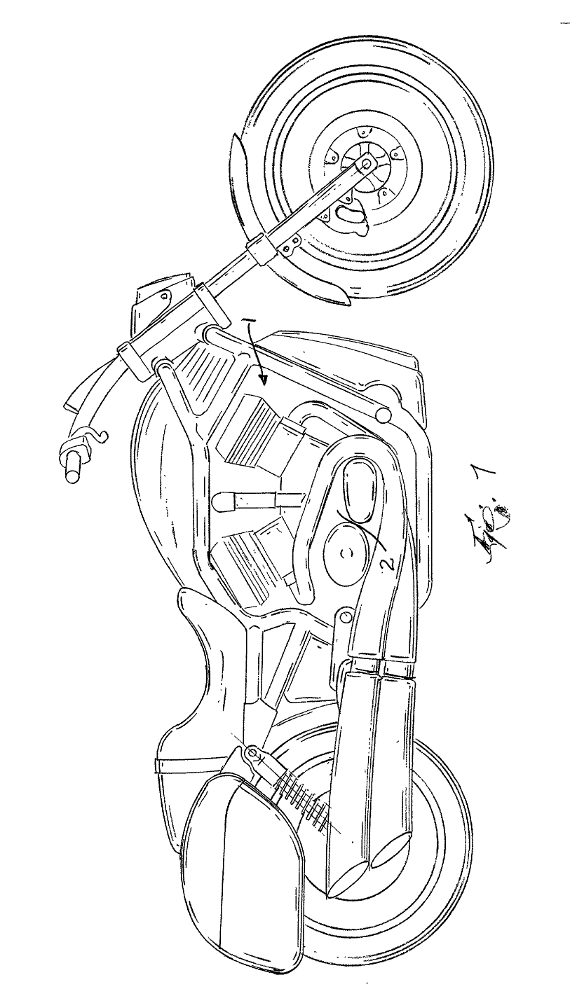

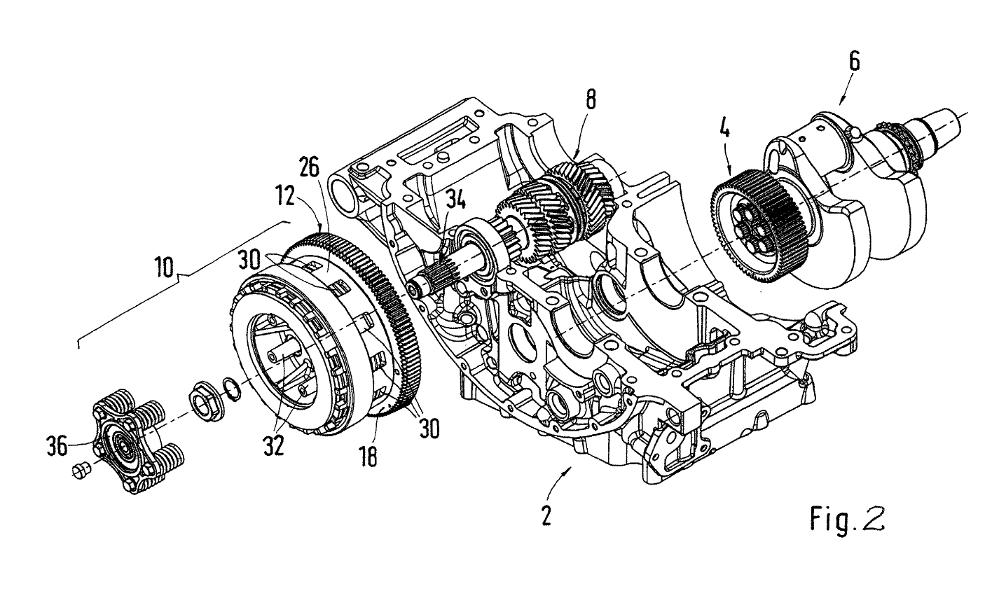

FIG. 1 illustrates a motorcycle that includes an engine 1 having a crankcase or engine housing 2. The crankcase 2 includes upper and lower parts, the lower part being illustrated in FIG. 2. A driven shaft or crankshaft 6 that is provided with a primary driven gearwheel 4 is arranged in the lower part of the crankcase 2. A gearbox input or driving shaft 8, on which a friction clutch 10 is secured in order to transmit the engine torque, is illustrated in the crankcase 2.

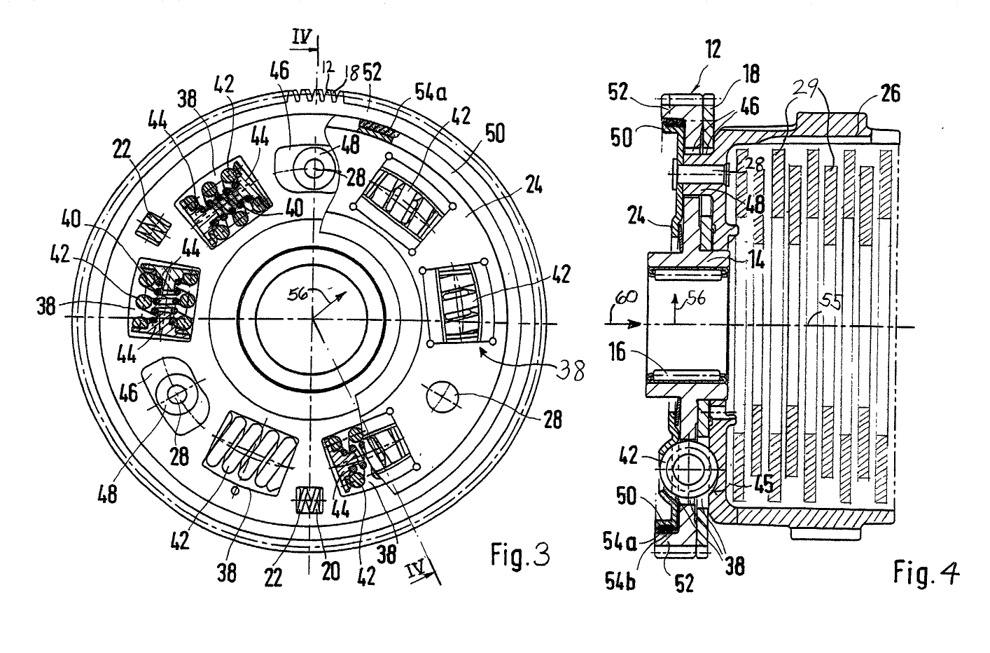

With reference to FIGS. 2-4, the illustrated friction clutch 10 is a multi-disc clutch including a driving gearwheel 12, which is provided with a central hub 14 (FIG. 4) mounted on the gearbox input shaft 8 in a rotatable manner by a needle bearing 16 (FIG. 4). A twist gearwheel 18, which in the fitted state engages with the primary gearwheel 4 of the crankshaft 6 in the same way as the driving gearwheel 12, is mounted on the hub 14. Window-like openings 20, in which twist springs 22 are received, are arranged on the end face of the driving gearwheel 12 and the twist gearwheel 18. The twist springs 22 bias the driving gearwheel 12 and the twist gearwheel 18 such that the external set of teeth of the twist gearwheel 18 is arranged slightly circumferentially offset with respect to the external set of teeth of the driving gearwheel 12. This offset has the effect that, when the primary gearwheel 4 engages in the driving gearwheel 12, one flank side of the two gearwheels 4, 12 is in contact, whilst the other flank of the primary gearwheel 4 is supported on a flank of the twist gearwheel 18. As a result, noises caused by the toothing system are reduced.

The driving gearwheel 12 and the twist gearwheel 18 are clamped between a driving disc 24 and a clutch cage or friction coupling mechanism 26 by way of three riveted joints 28. Because the driving disc 24 is rigidly mounted to the clutch cage 26, the driving disk 24 is functionally part of the clutch cage 26. In the clutch cage 26 a plurality of clutch discs 29 are arranged alternately one behind the other in a known manner. Externally toothed driving discs, which consist for example of aluminum or steel, engage in grooves 30 in the clutch cage 26 and internally toothed driving discs engage an external set of teeth (not shown) of a clutch hub 32. The clutch hub 32 is positioned by way of an internal set of teeth (not shown) engaging an external set of teeth 34 of the gearbox input shaft 8. The clutch discs arranged in the clutch cage 26 are pressed against one another in a known manner by way of a thrust plate 36, which is provided with compression springs and which is bolted to the clutch hub 32.

Window-like openings 38 are provided on a peripheral line both in the twist gearwheel 18 and in the driving gearwheel 12 and the driving disc 24. The window-like openings 38 are in alignment with one another in the assembled state, and are used for receiving an elastic coupling member. The illustrated elastic coupling member includes an inner and an outer torsion spring 40, 42. The ends of the two torsion springs 40, 42 are supported on spring plates 44, which are supported in turn on the edge of the window-like openings 38. A plurality of arc-shaped recesses 45 in the clutch cage 26 are in alignment with the openings 38 and are likewise used to support the torsion springs 40, 42. Three further slots or openings 46, arranged distributed on a peripheral line, are used to receive three rivet domes 48, which are integrally cast on the clutch cage 26 and in which the riveted joint 28 is received. The openings 46 are dimensioned in such a way with respect to the rivet domes 48 that the clutch cage 26 is received in a rotatably movable manner by the torsion springs 40, 42 in specific limits with respect to the driving gearwheel 12 such that the rivet domes 48 do not engage the ends of the slots 46.

The external periphery of the driving disc 24 has a collar 50 that is formed in one piece from the driving disc 24 and rests with non-positive locking against an inner side of a collar 52 of the driving gearwheel 12. The non-positive locking between the collar 50 of the driving disc 24 and the collar 52 of the driving gearwheel 12 takes place in a first embodiment by way of two friction rings 54a, 54b that are inserted in recesses provided in a corresponding manner therefor in the collar 50. The friction rings 54a, 54b together constitute a friction device or damping element.

The torsional vibrations arising as a result of the rhythmic sequence of engine cylinder firing can be damped by the cooperation of the torsion springs 40, 42 and the above-described friction rings 54a, 54b that are between the driving disc 24 and the driving gearwheel 12. Because the friction rings 54a, 54b engage the driving gearwheel 12 near the external diameter of the clutch, relatively low frictional forces are required to dampen the torsional vibrations.

The driving gearwheel 12 pivots about a pivot axis 55, and the friction device 54a, 54b acts in a radial direction (e.g. is subjected to compressive forces in the radial direction) with respect to the pivot axis 55. This configuration of the friction device 54a, 54b is an improvement over known friction clutches that require the vibration damper (e.g., a Belleville washer) to act in an axial direction 60 (FIG. 4). Such known vibration dampers therefore require that the driving disc 24 be tightened in the axial direction 60 against the driving gearwheel 12, which in turn may cause the drive gearwheel 12 to be pressed against the twist gear wheel 18 and clutch cage 26. Because the friction device 54a, 54b of the present invention acts only in the radial direction, the twist gearwheel 18 remains substantially unaffected by the frictional forces exerted upon the driving gearwheel 12.

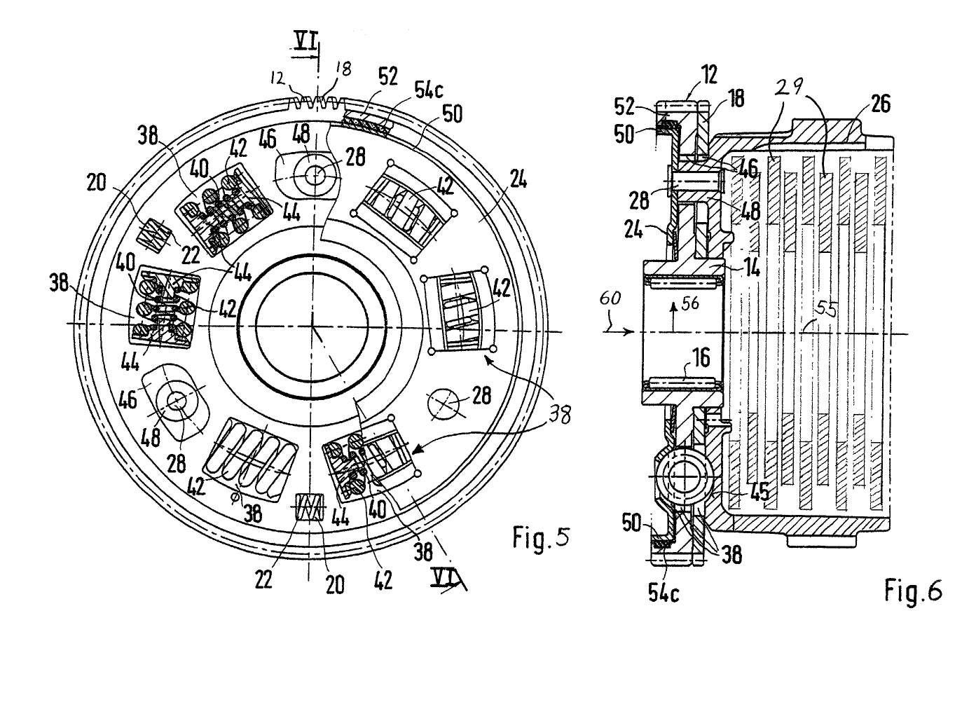

A second embodiment of a friction device that acts radially upon the driving gearwheel 12 is illustrated in FIGS. 5 and 6. In this case the friction member 54c, which is made rectangular in cross-section, is inserted in a recess provided on the inside of the collar 52. Similar to the first embodiment, the friction moment created by the friction member 54c that damps the torsional vibrations acts radially upon the driving gearwheel 12 by way of the collar 50 of the driving disc 24 and the friction member 54c.

The material used for the friction rings 54a, 54b, 54c may include metallic materials, such as for example bronze, aluminum or steel, as well as non-metallic materials, such as for example plastic, rubber or other synthetics.

Various features of the invention are set forth in the following claims.

1. A friction clutch comprising:
a clutch cage;
a driving gearwheel rotatably coupled to the clutch cage for rotation about an axis; and
a friction element compressed between the clutch cage and the driving gearwheel by a substantially radial force.

2. The friction clutch of claim 1, further comprising a twist gearwheel and a twist spring between the twist gearwheel and the driving gearwheel, the twist spring biasing the twist gearwheel and the driving gearwheel toward circumferentially offset positions.

3. The friction clutch of claim 1, further comprising torsion springs between the driving gearwheel and the clutch cage, said torsion springs being the sole means for coupling the driving gearwheel and the clutch cage for rotation together, wherein the friction element dampens oscillations of the torsion springs as the driving gearwheel and the clutch cage rotate with respect to each other.

4. The friction clutch of claim 1, wherein the clutch cage includes a driving disc and wherein the driving disc axially secures the driving gearwheel to the clutch cage.

5. The friction clutch of claim 1, wherein the clutch cage includes a first radial surface and the driving gearwheel includes a second radial surface facing the first radial surface, and wherein the friction element is compressed between the first and second radial surfaces.

6. The friction clutch of claim 1, wherein the friction element includes first and second O-ring members, and wherein the O-ring members are made of steel.

7. A motorcycle comprising:
a frame;
a rear wheel supporting a rear end of the frame;
a front wheel supporting a front end of the frame;
an engine assembly mounted to the frame and having a rotating output shaft; and
a friction clutch selectively operable to couple the output shaft and the rear wheel, the friction clutch comprising:
a clutch cage;
a driving gearwheel rotatably coupled to the clutch cage for rotation about an axis; and
a friction element compressed between the clutch cage and the driving gearwheel by a substantially radial force.

8. The motorcycle of claim 7, further comprising a twist gearwheel and a twist spring between the twist gearwheel and the driving gearwheel, the twist spring biasing the twist gearwheel and the driving gearwheel toward circumferentially offset positions.

9. The motorcycle of claim 7, further comprising torsion springs between the driving gearwheel and the clutch cage, said torsion springs being the sole means for coupling the driving gearwheel and the clutch cage for rotation together, wherein the friction element dampens oscillations of the torsion springs as the driving gearwheel and the clutch cage rotate with respect to each other.

10. The motorcycle of claim 7, wherein the clutch cage includes a driving disc and wherein the driving gearwheel is interposed between the clutch cage and the driving disc.

11. The motorcycle of claim 7, wherein the clutch cage includes a first radial surface and the driving gearwheel includes a second radial surface facing the first radial surface, and wherein the friction element is compressed between the first and second radial surfaces.

12. The motorcycle of claim 7, wherein the friction element includes first and second O-ring members, and wherein the O-ring members are made of steel.

13. A method of damping oscillations in a friction clutch having a clutch cage and a driving gearwheel pivotally coupled together for rotation about an axis, the method comprising:
providing an elastic coupling member between the clutch cage and the driving gearwheel;
radially compressing a friction element between the clutch cage and the driving gearwheel;
transferring rotation of the driving gearwheel to the clutch cage via the elastic coupling member, the elastic coupling member oscillating in response to rotation of the clutch cage and the driving gearwheel; and
damping oscillations of the elastic coupling member with frictional forces provided by the friction element.

14. The method of claim 13, further comprising:
providing a twist gearwheel and a twist spring between the twist gearwheel and the driving gearwheel; and
biasing the twist gearwheel and the driving gearwheel toward circumferentially offset positions with the twist spring.

15. The method of claim 13, further comprising securing a driving disk to the clutch cage and interposing the driving gearwheel between the clutch cage and the driving disc.

16. The method of claim 13, wherein the clutch cage includes a first radial surface and the driving gearwheel includes a second radial surface facing the first radial surface, and wherein radially compressing the friction element comprises compressing the fiction element between the first and second radial surfaces.

17. A friction clutch for coupling a driving shaft and a driven shaft for rotation together, the friction clutch comprising:
a friction coupling mechanism frictionally coupled to the driving shaft;
a driving gearwheel engaging a driven gearwheel on the driven shaft, said driving gearwheel being pivotable with respect to said friction coupling mechanism about a pivot axis;
an elastic coupling member interconnecting said driving gearwheel and said friction coupling mechanism, and permitting said driving gearwheel to pivot with respect to said friction coupling mechanism within a limited range of motion; and,
a damping member frictionally engaging said driving gearwheel in a radial direction perpendicular to said pivot axis to dampen torsional vibrations between the driving gearwheel and the friction coupling mechanism.

18. The friction clutch of claim 17, wherein said driving gearwheel includes a collar at least partially defining a cavity, said friction clutch further comprising a driving disc within said cavity and including a collar along its periphery, wherein said damping member frictionally engages said collars.

19. The friction clutch of claim 17, wherein said elastic coupling member comprises a torsion spring providing a substantially circumferential biasing force between said driving gearwheel and said friction coupling mechanism.
